(19) United States
(12) Patent Application Publication
(10) Pub. No.: US 2025/0141509 A1
(43) Pub. Date: May 1, 2025

(54) Massive Multiple Input Multiple Output Radio Unit Uplink Interface

(71) Applicant: Telefonaktiebolaget LM Ericsson (PUBL), Stockholm (SE)

(72) Inventors: Jonas Karlsson, UPPLANDS VÄSBY (SE); Stéphane Tessier, STOCKHOLM (SE); Fredrik Huss, SUNDBYBERG (SE)

(21) Appl. No.: 18/836,655

(22) PCT Filed: Feb. 8, 2023
(86) PCT No.: PCT/EP2023/053111

§ 371 Date: Aug. 7, 2024

Related U.S. Application Data
(60) Provisional application No. 63/307,675, filed on Feb. 8, 2022.

(51) Int. Cl. H04B 7/06; H04B 17/309; H04W 76/38

(52) U.S. Cl. CPC H04B 7/0617; H04B 17/346; H04W 76/38

(57) ABSTRACT

A method 1400 by at least one RE of a network node includes performing a channel quality estimation, a calculation of at least one BFW, and a port reduction with respect to input data and/or an input signal. The RE transmits, to a REC, measurement information associated with the channel quality estimation, the calculation of the at least one BFW, and the port reduction.

### TECHNICAL FIELD

The present disclosure relates, in general, to wireless communications and, more particularly, systems and methods for providing a Massive-Multiple Input Multiple Output (Massive-MIMO) radio unit uplink interface.

### BACKGROUND

One of the aims of the Open-Radio Access Network (O-RAN) Alliance is to standardize what has been termed a lower layer split. See, O-RAN WG4 specifications, https://www.o-ran.org/specifications. This split defines an interface between the radio equipment controller (REC) and the radio equipment (RE) in a radio access network (RAN) communication system. There are several different ways the functional division can be done between the REC and RE. See, 3GPP TR 38.816 V15.0.0, “Study on CU-DU lower layer split for NR”.

The O-RAN specification has chosen a split that is close to the 7-2 functional split (as defined in the O-RAN WG4 specifications). For the uplink this means that Fast Fourier Transform (FFT)/Cyclic Prefix (CP) removal, beamforming, and resource element de-mapping are located in the RE, and that channel estimation/equalization, Inverse Discrete Fourier Transform (IDFT), de-modulation, and decoding are located in the REC. See, U.S. Pat. No. 11,128,322, “Methods and devices for determination of beamforming information,” issued Sep. 21, 2021.

There currently exist certain challenge(s). For example, the current O-RAN specification for the uplink, in particular for Massive-MIMO products, does not provide good throughput performance and low front haul bitrates at the same time. There is a choice of either having good throughput performance or low front haul bitrates. The reason for this is that the beamforming performed in the RE is dependent on the channel estimation performed in the REC, and this leads to the beamforming performed in RE being based on outdated channel and interference information. This is the case either due to the inherent periodicity of sounding reference signals (SRS), which is a typical use case, or due to the tough latency requirements on the signal processing that for demodulation reference signals (DMRS) that will prevent the RE to wait for updated beamforming weights (BFWs).

### SUMMARY

Certain aspects of the disclosure and their embodiments may provide solutions to these or other challenges. For example, according to certain embodiments, for example, methods and systems are provided that are based on a lower layer split where channel estimation/equalization is moved to the RE from the REC. This will enable the beamforming in the RE to be based on instantaneous channel and interference information, which then will give the high throughput and low front haul bitrates.

According to certain embodiments, a method by at least one RE of a network node includes, with respect to input data and/or an input signal, performing: a channel quality estimation, a calculation of at least one beamforming weight, and a port reduction. The RE transmits, to a REC, measurement information associated with the channel quality estimation, the calculation of the at least one beamforming weight, and the port reduction.

According to certain embodiments, an RE of a network node is adapted to perform channel quality estimation, a calculation of at least one beamforming weight, and a port reduction with respect to input data and/or an input signal. The RE is adapted to transmit, to a REC, measurement information associated with the channel quality estimation, the calculation of the at least one beamforming weight, and the port reduction.

According to certain embodiments, a method by an REC of a network node includes receiving, from at least one RE, measurement information. The measurement information is associated with: a channel quality estimation performed by the RE, a calculation of at least one beamforming weight by the RE, and a port reduction by the RE.

According to certain embodiments, an REC of a network node is adapted to receive, from at least one RE, measurement information. The measurement information is associated with: a channel quality estimation performed by the RE, a calculation of at least one beamforming weight by the RE, and a port reduction by the RE.

Certain embodiments may provide one or more of the following technical advantage(s). For example, certain embodiments may provide a technical advantage of placing the channel estimation and/or equalization function in the RE so as to give high throughput and low front haul bitrates at the same time. As a result, one does not need to choose between providing high throughput and providing low front haul bitrates. As another example, certain embodiments may provide a technical advantage of transferring information from the RE to the REC to provide good throughput performance. Specifying this information in a flexible way enables improvements to be made without the need to change the protocol specification in the future.

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates an example access node with the REC and RE communicating with UEs, according to certain embodiments;

FIG. 2 illustrates the existing lower layer split as specified by the current specifications for O-RAN WG4;

FIG. 3 illustrates an example lower layer split that includes a new division line for assigning functions to the O-RU and the O-DU, according to certain embodiments;

FIG. 4 illustrates an example of how the DMRS Channel estimation is related to IpN estimation, according to certain embodiments;

FIG. 5 illustrates an example of TA measurement being estimated in the O-RU (i.e., RE), according to certain embodiments;

FIG. 6 illustrates an example of Frequency Offset measurement being estimated in the O-RU (i.e., RE), according to certain embodiments;

FIG. 7 illustrates an example for enabling the O-DU (i.e., REC) to provide control information to the O-RU (i.e., RE), according to certain embodiments;

FIG. 8 illustrates an example communication system, according to certain embodiments;

FIG. 9 illustrates an example UE, according to certain embodiments;

FIG. 10 illustrates an example network node, according to certain embodiments;

FIG. 11 illustrates a block diagram of a host, according to certain embodiments;

FIG. 12 illustrates a virtualization environment in which functions implemented by some embodiments may be virtualized, according to certain embodiments;

FIG. 13 illustrates a host communicating via a network node with a UE over a partially wireless connection, according to certain embodiments;

FIG. 14 illustrates a method by at least one RE of a network node, according to certain embodiments; and

FIG. 15 illustrates a method by at least one REC of a network node, according to certain embodiments.

### DETAILED DESCRIPTION

Some of the embodiments contemplated herein will now be described more fully with reference to the accompanying drawings. Embodiments are provided by way of example to convey the scope of the subject matter to those skilled in the art.

As used herein, ‘node’ can be a network node or a UE. Examples of network nodes are NodeB, base station (BS), multi-standard radio (MSR) radio node such as MSR BS, eNodeB (eNB), gNodeB (gNB), Master eNB (MeNB), Secondary eNB (SeNB), integrated access backhaul (IAB) node, network controller, radio network controller (RNC), base station controller (BSC), relay, donor node controlling relay, base transceiver station (BTS), Central Unit (e.g. in a gNB), Distributed Unit (e.g. in a gNB), Baseband Unit, Centralized Baseband, C-RAN, access point (AP), transmission points, transmission nodes, Remote Radio Unit (RRU), Remote Radio Head (RRH), nodes in distributed antenna system (DAS), core network node (e.g. Mobile Switching Center (MSC), Mobility Management Entity (MME), etc.), Operations & Maintenance (O&M), Operations Support System (OSS), Self Organizing Network (SON), positioning node (e.g. E-SMLC), etc.

Another example of a node is user equipment (UE), which is a non-limiting term and refers to any type of wireless device communicating with a network node and/or with another UE in a cellular or mobile communication system. Examples of UE are target device, device to device (D2D) UE, vehicular to vehicular (V2V), machine type UE, MTC UE or UE capable of machine to machine (M2M) communication, Personal Digital Assistant (PDA), Tablet, mobile terminals, smart phone, laptop embedded equipment (LEE), laptop mounted equipment (LME), Unified Serial Bus (USB) dongles, etc.

In some embodiments, generic terminology, “radio network node” or simply “network node (NW node)”, is used. It can be any kind of network node which may comprise base station, radio base station, base transceiver station, base station controller, network controller, evolved Node B (eNB), Node B, gNodeB (gNB), relay node, access point, radio access point, Remote Radio Unit (RRU) Remote Radio Head (RRH), Central Unit (e.g. in a gNB), Distributed Unit (e.g. in a gNB), Baseband Unit, Centralized Baseband, C-RAN, access point (AP), etc.

The term radio access technology (RAT), may refer to any RAT such as, for example, Universal Terrestrial Radio Access Network (UTRA), Evolved Universal Terrestrial Radio Access Network (E-UTRA), narrow band internet of things (NB-IoT), WiFi, Bluetooth, next generation RAT, NR, 4G, 5G, etc. Any of the equipment denoted by the terms node, network node or radio network node may be capable of supporting a single or multiple RATs.

As noted above, with regard to Massive-MIMO products, a choice has to be typically made of either having good throughput performance or low front haul bitrates since the beamforming performed in the RE is dependent on the channel estimation performed in the REC and, thus, the beamforming performed in RE is typically based on outdated channel and interference information. Further, since the current O-RAN specification has both channel estimation/equalization and demodulation on the REC, there is no signaling defined between these two entities.

According to certain embodiments described herein, however, methods and systems are provided that are based on a lower layer split where channel estimation and/or equalization are moved from the REC to the RE. As a result, beamforming in the RE may be based on instantaneous channel and interference information, which may result in high throughput and low front haul bitrates.

Additionally, according to certain embodiments, methods and systems are provided that define the information and the format of the information that is transmitted from the RE to the REC. More specifically, in order for the performance of channel estimation and/or equalization by the RE to be a complete and adjustable solution, certain embodiments propose transferring information from the RE to the REC in a flexible way. This information may be in addition to the equalized In-phase and Quadrature data (IQ-data). Thus, certain embodiments described herein define what information is provided and what options should be part of the interface protocol definition between REC and RE. For example, in a particular embodiment, the demodulator in the REC needs Signal-to-Noise/Interference-Ratio (SNIR) values from the channel estimator in the RE, and these values can be transferred with different time and frequency resolutions, which is to be specified, according to certain embodiments.

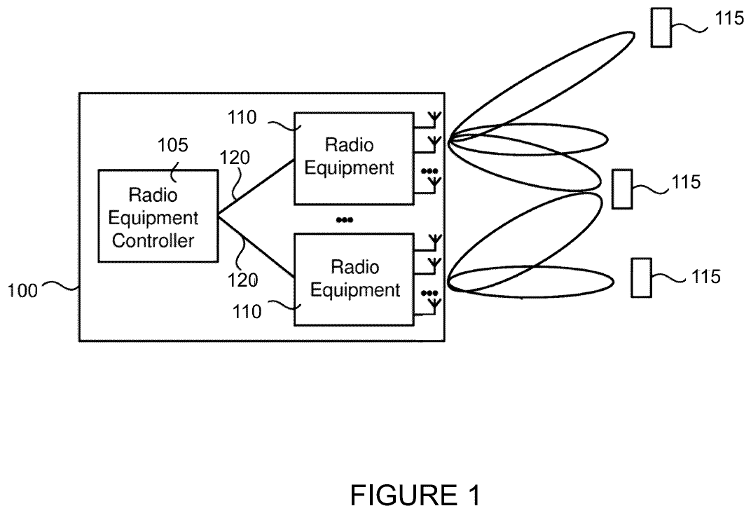

FIG. 1 illustrates an example access node 100 with the REC 105 and RE 110 communicating with UEs 115, according to certain embodiments. Additionally, access node 100 includes a lower layer split interface 120.

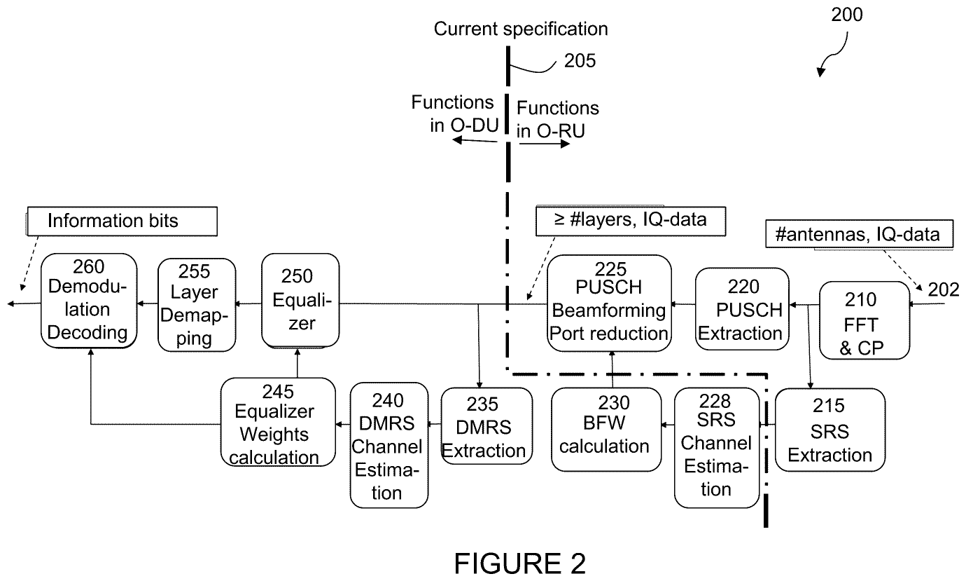

FIG. 2 illustrates the existing lower layer split 200 as specified by the current specifications for O-RAN WG4. Specifically, line 205 shows division of operations by the lower layer split as defined by the current specification. Functions on the right side of line 205 are performed by the O-RAN-Radio Unit (O-RU), and functions on the left side of line 205 are performed by the O-RAN-Distributed Unit (O-DU). Thus, as shown, the current specification has beamforming and port reduction being performed in the RE and channel estimation, BFW calculation, equalization, demodulation and decoding being performed in the REC. It is noted that in O-RAN, the REC is called O-DU and the RE is called O-RU. However, though FIG. 2 depicts the functions performed by the O-DU and O-RU and certain embodiments are described with respect to the O-DU and O-RU, the techniques described herein are not limited to O-RAN implementations. As such, herein, the terms O-DU and REC are used interchangeably, and the terms O-RU and RE are used interchangeably.

As illustrated in FIG. 2, current specifications for O-RAN FFT and Cyclic Prefix removal 210, SRS Extraction 215, PUSCH Extraction 220, and PUSCH Beamforming/Port Reduction 225 are functions performed in/by the O-RU. SRS Channel Estimation 228, BFW Calculation 230, DMRS Extraction 235, DMRS Channel Estimation 240, Equalizer Weights Calculation 245, Equalizer 250, Layer Demapping 255, and Demodulation/Decoding 260 are performed in/by the O-DU.

Entering FIG. 2 from the right, one IQ-data stream 202 for each of the receiver antennas is the input the FFT and cyclic prefix (CP) removal block 210. For a typical Massive MIMO product in the 2-3.5 GHz frequency range, the number of antenna IQ-data streams 202 are in the order of 64. After PUSCH Beamforming/Port Reduction 225, the number of IQ-data streams is reduced.

If the lowest possible bitrate is preferred for the front haul, the number of IQ-data streams of the interface from the O-RU (i.e., RE) to the O-DU (i.e., REC) should be equal to the number of layers received. However, the current O-RAN specification allows for a greater number of IQ-data streams than the number of layers. A “layer” is a 3GPP terminology corresponding to a stream of information bits. A single UE can be assigned multiple layers to increase the single-user bit rate, which is referred to as SU-MIMO. Additionally or alternatively, multiple UEs can be assigned layers at the same time, which is referred to as MU-MIMO.

Typically, the uplink user throughput becomes poor if the number of IQ-data steams is selected to be equal to the number of layers, so in order to get better performance, the number of IQ-data streams needs to be increased.

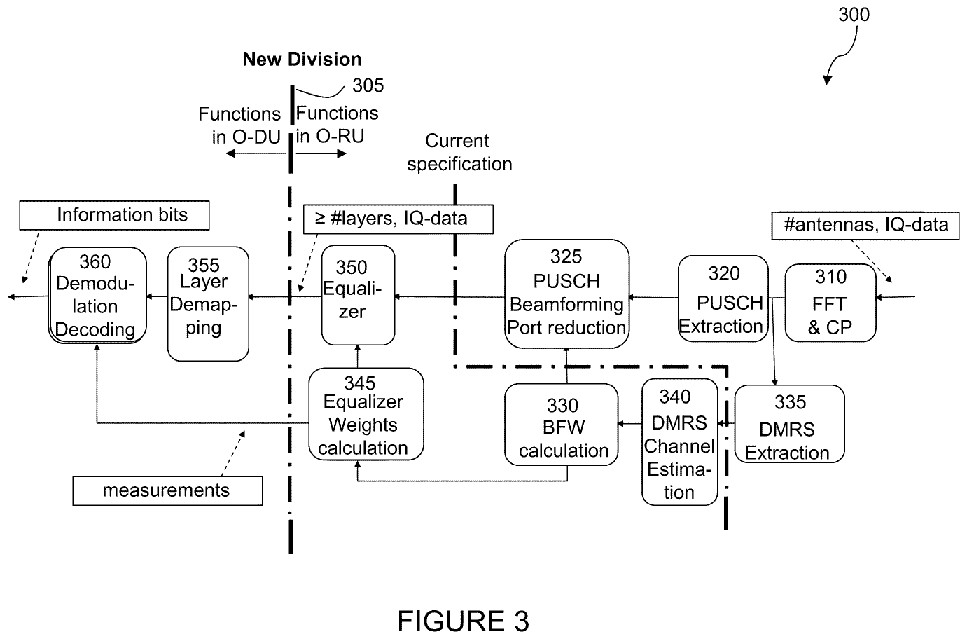

FIG. 3 illustrates an example lower layer split 300 that includes a new division line 305 for assigning functions to the O-RU and the O-DU, according to certain embodiments. Specifically, FFT and Cyclic Prefix removal 310, DMRS Extraction 335, PUSCH Extraction 320, and PUSCH Beamforming/Port Reduction 325 are still functions performed in/by the O-RU. Additionally, however, the DMRS channel Estimation 340, BFW Calculation 330, Equalizer Weight Calculation 345, and the Equalizer 350 are moved from the O-DU (i.e., REC) to the O-RU (i.e., RE), according to certain embodiments. Layer Demapping 355 and Demodulation/Decoding 360 remain functions of the O-DU (i.e., REC).

With the division shown in FIG. 3, the number of IQ-data streams from the O-RU (i.e., RE) to the O-DU (i.e., REC) can be equal to the number of layers without sacrificing user throughput.

It may be noted that the blocks in FIG. 3 should be seen as conceptional or functional blocks. What is significant is the interface between the O-DU (i.e., REC) and the O-RU (i.e., RE), which is denoted as New Division line 305 in FIG. 3. An actual implementation can, for example, implement functions that are shown as being performed separately in FIG. 3 in one unit. For example, Beamforming/Port Reduction 325 and Equalization 350 as one unit. Similarly, the BFWs Calculation 330 and the Equalizer Weights Calculation 345 can be implemented as one unit, in a particular embodiment.

In addition to the IQ-data streams with the equalized user data, a couple of measurements need to be transferred from the O-RU (i.e., RE) to the O-DU (i.e., REC). Different measurements can be used for different purposes. In order for the RE and REC to work well together, the interface need to specify how to transfer these measurements and the measurements themselves need to be defined.

Since these measurements might be needed with different resolutions and accuracies in the future, they should be specified in such a way that it can be configured with different resolutions without the need to update the specification.

### Signal-to-Noise/Interference-Ratio (SNIR)

One example of demodulation is Log-Likelihood Ratio (LLR) Demodulation. See, https://www.mathworks.com/help/comm/ug/log-likelihood-ratio-llr-demod-ulation.html. In addition to the equalized IQ-data, this demodulator also needs to information about the signal level and the noise/interference level, or rather the SNIR.

The time-frequency grid of the received signal is (by the 3GPP standard) divided into physical resource blocks (PRBs). One PRB consists of a number of subcarriers (e.g., 12) and a number of symbols. The finest resolution that could be needed is to provide one SNIR value per subcarrier and per symbol. However, typically one SNIR value per PRB is a better choice.

According to certain embodiments, the protocol that defines the RE-to-REC interface should be able to configure the SNIR measurements with different frequency resolutions and different time resolutions. For example, different frequency resolutions may include: one SNIR value per 1 subcarrier, 2 subcarriers, 3 subcarriers, 4 subcarriers, 6 subcarriers, 12 subcarriers, 24 subcarriers or the whole carrier (i.e. only one value for the whole carrier). For example, different time resolutions may include: one SNIR value per 1 symbol, 2 symbols, 4 symbols, 7 symbols or 14 symbols. In various particular embodiments, the protocol may allow:
different frequency resolutions only, or
different time resolutions only, or
both different frequency and time resolutions only, or
only one fixed frequency and time resolution.

SNIR values may be defined as the average Signal Interference to Noise Ratio (SINR) over the configured time/frequency resolution for each layer and user, for the full PUSCH allocation. SNIR is per time and frequency unit over a PUSCH allocation for each layer and user.

In a particular embodiment, which may be considered a variant of the SNIR measurement, beta-values may be used. For example, according to certain embodiments, the SNIR requires a floating-point number representation to be transferred from the RE to the REC. A way to compress the measurement data, to reduce the front haul bitrates, is to rewrite the SNIR as beta=SNIR/(SNIR+1), in a particular embodiment. This creates a variable beta that has the range 0 to 1, which can be represented as a fixed-point number.

### Interference-Plus-Noise (IpN)

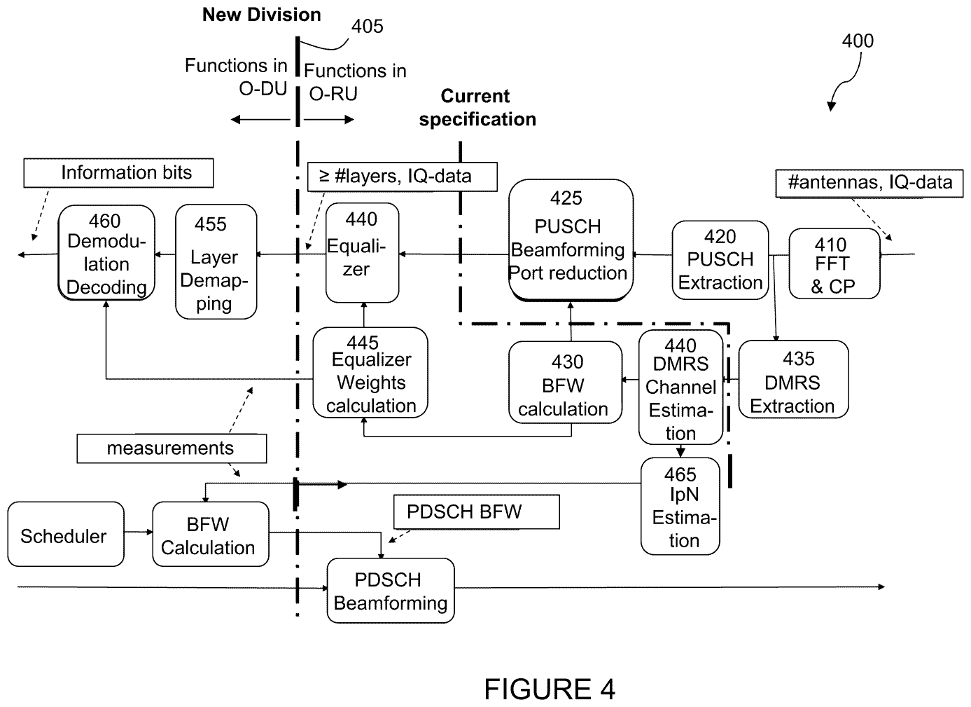

FIG. 4 illustrates an example 400 of how the DMRS Channel estimation is related to IpN estimation, according to certain embodiments. Specifically, as described below, IpN estimation may be used for the PUSCH BFW calculations.

Similar to FIG. 3, FIG. 4 shows the new division line 405 for assigning functions to the O-RU and the O-DU, according to certain embodiments. Also, like FIG. 3, FFT and Cyclic Prefix removal 410, DMRS Extraction 435, PUSCH Extraction 420, and PUSCH Beamforming/Port Reduction 425, DMRS channel Estimation 440, BFW Calculation 430, Equalizer Weight Calculation 445, and the Equalizer 450 are functions performed in the O-RU (i.e., RE), while Layer Demapping 455 and Demodulation/Decoding 460 are the functions of the O-DU (i.e., REC).

However, FIG. 4 also shows IpN Estimation 465 being performed by the O-RU (i.e., RE). In a particular embodiment, the well-known Minimum Mean Square Error (MMSE) method that can be used to calculate BFWs uses an IpN estimate as one of its's inputs. This is sometimes also called the regularization factor.

IpN can be defined as the average over a defined period of time of the IpN measurement per PRB after that known PUSCH signals (known intra-cell signals) have been removed (in dBM).

Accordingly, certain embodiments include the O-RU performing IpN estimation 465. In particular, as illustrated, the protocol that defines the RE-to-REC interface is able to configure the IpN measurements with different frequency resolutions. For example, different frequency resolutions may include: one IpN value per 1 PRB, 2 PRBs, or the whole carrier (i.e. only one value for the whole carrier). In various embodiments, the protocol may allow:
different frequency resolutions only, or
only one fixed frequency resolution.

### Timing Advance (TA)

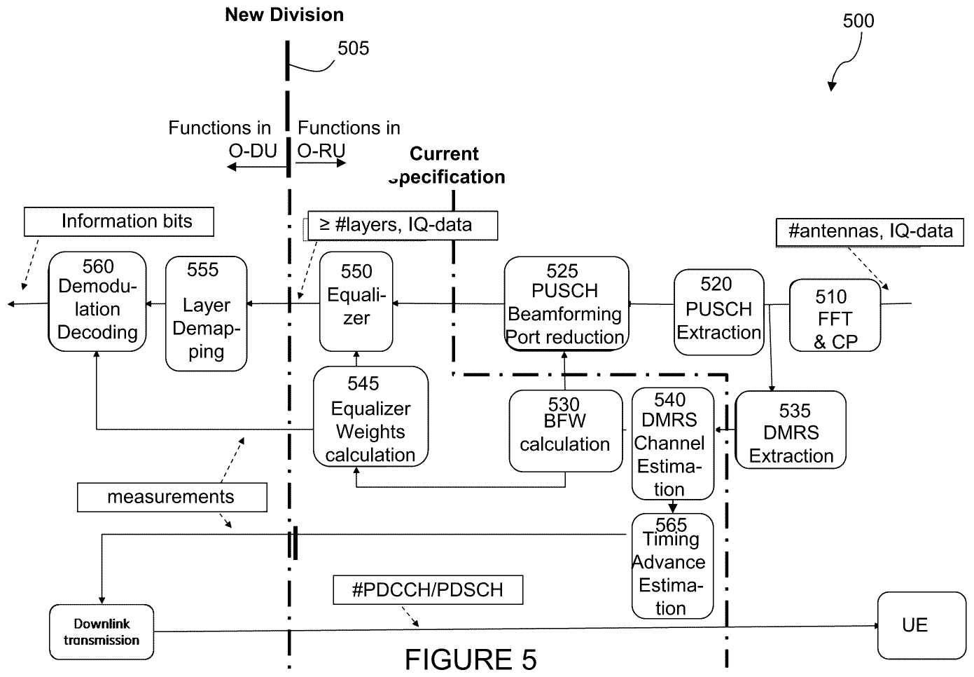

FIG. 5 illustrates an example 500 of TA measurement being estimated in the O-RU (i.e., RE), according to certain embodiments. In particular, the TA measurement may be estimated in the O-RU (i.e., RE) and transferred to the O-DU (i.e., REC) and then sent to the UE.

Similar to the figures above, FIG. 5 shows the new division line 505 for assigning functions to the O-RU and the O-DU, according to certain embodiments. Also, like the preceding Figures, FIG. 5 shows FFT and Cyclic Prefix removal 510, DMRS Extraction 535, PUSCH Extraction 520, and PUSCH Beamforming/Port Reduction 525, DMRS channel Estimation 540, BFW Calculation 530, Equalizer Weight Calculation 545, and the Equalizer 550 are functions performed in the O-RU (i.e., RE), while Layer Demapping 555 and Demodulation/Decoding 560 are the functions of the O-DU (i.e., REC).

However, FIG. 5 also shows TA Estimation 565 being performed by the O-RU (i.e., RE). According to certain embodiments, for example, in order for the UEs to be time synchronized with the O-RU receiver, TA measurement(s) are performed by the access node, and TA commands are transmitted to the UE so that the UE may adjust its transmission timing. In particular embodiments, the UEs need to be synchronized in time to avoid intercarrier and inter-symbol interference. TA measurement reports the time-of-arrival of the received signals so that appropriate timing-advance commands can be transmitted to the UEs

The TA measurement needs to be transferred from the O-RU (i.e., RE) to the O-DU (i.e., REC) for each UE, and for each carrier.

### Frequency Offset

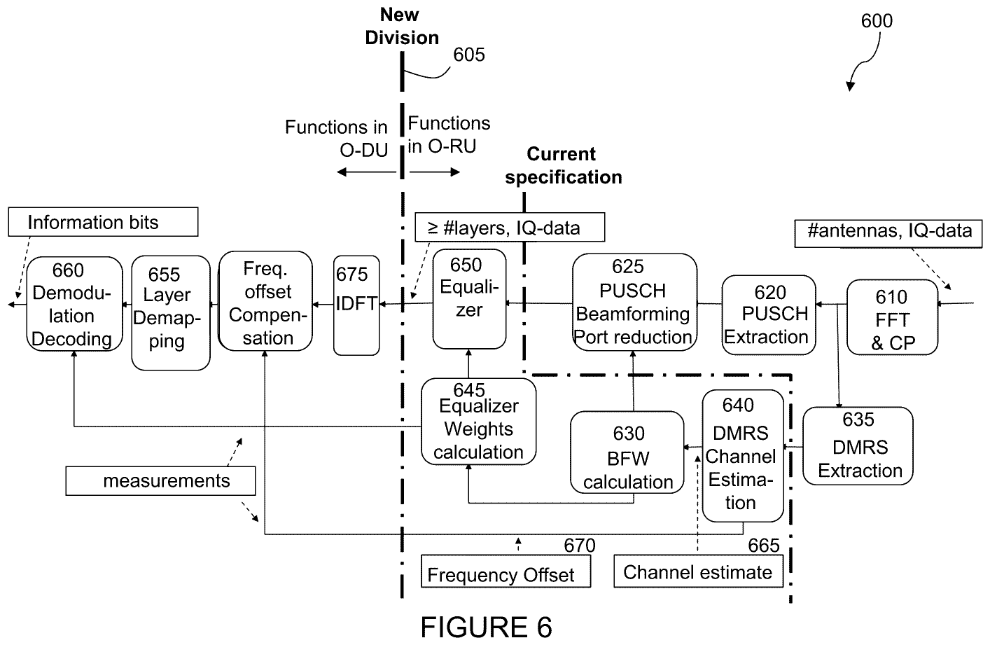

FIG. 6 illustrates an example 600 of Frequency Offset measurement being estimated in the O-RU (i.e., RE), according to certain embodiments. In particular, frequency offset may be estimated in the O-RU (i.e., RE) and transferred to the O-DU (i.e., REC) for the O-DU to perform frequency offset compensation.

Similar to the figures above, FIG. 6 shows the new division line 605 for assigning functions to the O-RU and the O-DU, according to certain embodiments. Also, like the preceding Figures, FIG. 6 shows FFT and Cyclic Prefix removal 610, DMRS Extraction 635, PUSCH Extraction 620, PUSCH Beamforming/Port Reduction 625, DMRS channel Estimation 640, BFW Calculation 630, Equalizer Weight Calculation 645, and the Equalizer 650 are functions performed in the O-RU (i.e., RE), while Layer Demapping 655 and Demodulation/Decoding 660 are the functions of the O-DU (i.e., REC).

However, FIG. 6 also shows Channel Estimation 665 and Frequency Offset Estimation 670 being performed by the O-RU (i.e., RE). In particular, and due to various reasons such as, for example, frequency errors in the UE transmitter and Doppler effects, the received signal from a UE might have a frequency error. Such an error will cause leakage of signal energy between subcarriers and therefore degrade the throughput performance. Frequency Offset is a measurement of the carrier frequency of a UE's received signal relative to the nominal carrier frequency.

The frequency offset compensation can in theory be performed either before or after the IDFT function 675. However, it's typically more computationally efficient to perform it after the IDFT. For a solution with the IDFT function 675 in the O-DU (i.e., REC) as shown in FIG. 6, the O-RU (i.e., RE) will be needed to transfer the frequency offset measurements from the O-RU to the O-DU in order to perform the frequency offset compensation after the IDFT. It is noted that the frequency offset measurement is transferred for each UE, and for each carrier.

### Control Information

When equalization/channel estimation is moved from the REC to the RE, as described in certain embodiments discussed above, the REC may provide certain information to the RE. For example, according to certain embodiments, the RE needs to have the information to perform channel estimation, beamforming and equalization. This includes both scheduling information (which resource elements that is used) per UE and which reference signals that the UE has transmitted. There could also be other kinds of information that would be beneficial for the REC to provide to the RE.

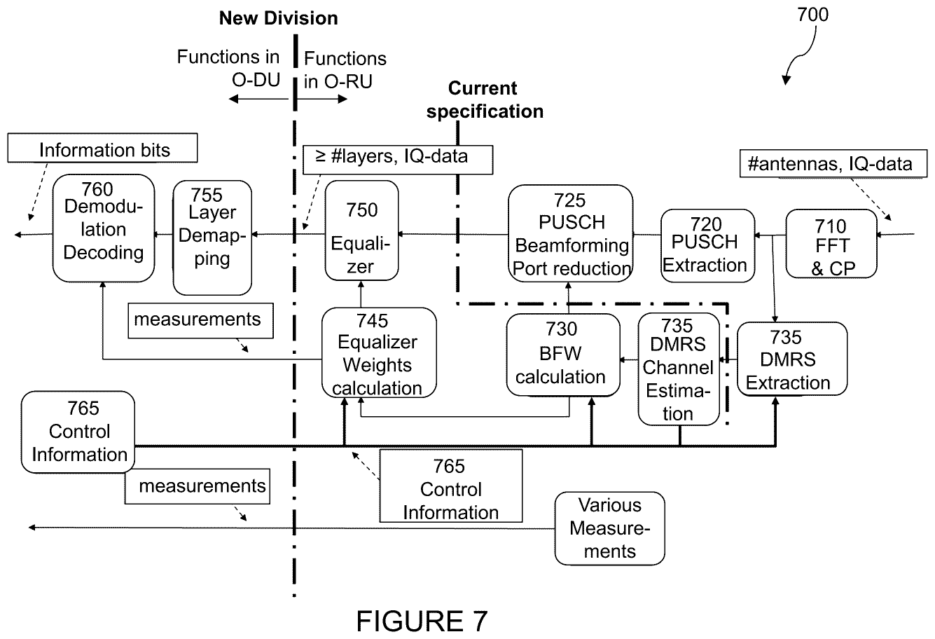

FIG. 7 illustrates an example 700 for enabling the O-DU (i.e., REC) to provide control information to the O-RU (i.e., RE), according to certain embodiments. Many of the functional blocks illustrated in example 700 are the same as those described above with respect to FIGS. 3-6. Thus, like the preceding figures, FIG. 7 shows FFT and Cyclic Prefix removal 710, DMRS Extraction 735, PUSCH Extraction 720, PUSCH Beamforming/Port Reduction 725, DMRS channel Estimation 740, BFW Calculation 730, Equalizer Weight Calculation 745, and the Equalizer 750 are functions performed in the O-RU (i.e., RE), while Layer Demapping 755 and Demodulation/Decoding 760 are the functions of the O-DU (i.e., REC).

However, FIG. 7 also shows control information 765 being transferred from the O-DU (i.e., REC) to four of the blocks inside the O-RU (i.e., RE). Specifically, control information 765 is sent to Equalizer Weights Calculation 745, BFW calculation 730, DMRS Channel Estimation 735, and DMRS Extraction 735. This is just one example, however. Some of the other blocks might also use control information, though it is not explicitly shown in FIG. 7. For example, in some embodiments, the PUSCH extraction 720 may also use control information provided by O-DU.

Note that the O-RU (i.e., RE) might be implemented with a different block structure than that shown in FIG. 7. In various embodiments, O-RU might be implemented using any of the block structures illustrated in FIGS. 2-6 or any other suitable block structure. The key point is that control information may be provided from the O-DU (i.e., REC) to the O-RU (i.e., RE) in order for the O-RU to perform the channel estimation, beamforming, equalization, or other functions.

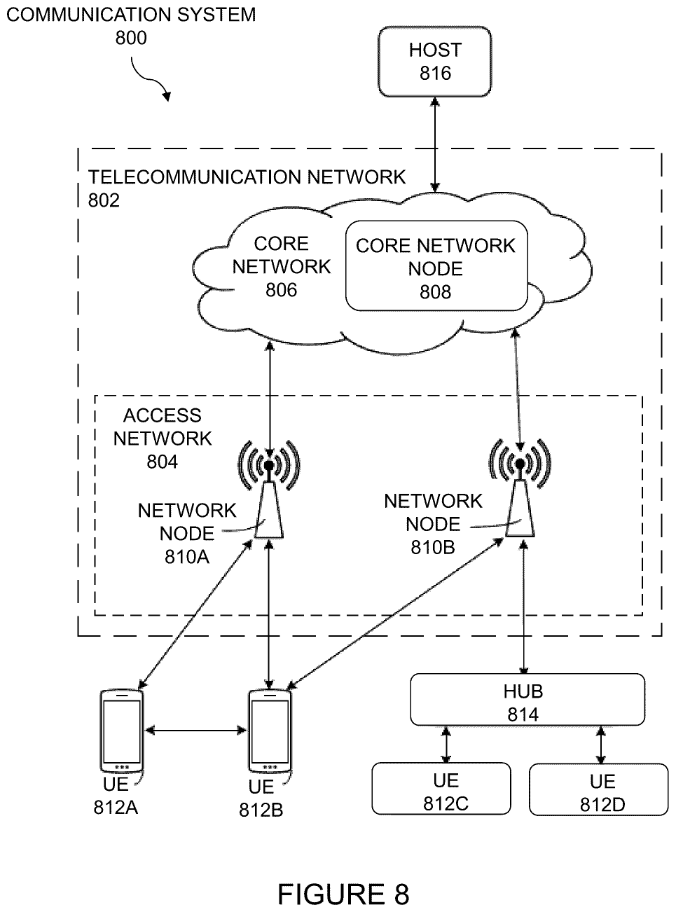

FIG. 8 shows an example of a communication system 800 in accordance with some embodiments. In the example, the communication system 800 includes a telecommunication network 802 that includes an access network 804, such as a radio access network (RAN), and a core network 806, which includes one or more core network nodes 808. The access network 804 includes one or more access network nodes, such as network nodes 810a and 810b (one or more of which may be generally referred to as network nodes 810), or any other similar 3rd Generation Partnership Project (3GPP) access node or non-3GPP access point. The network nodes 810 facilitate direct or indirect connection of user equipment (UE), such as by connecting UEs 812a, 812b, 812c, and 812d (one or more of which may be generally referred to as UEs 812) to the core network 806 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 800 may include any number of wired or wireless networks, network nodes, UEs, and/or any other components or systems that may facilitate or participate in the communication of data and/or signals whether via wired or wireless connections. The communication system 800 may include and/or interface with any type of communication, telecommunication, data, cellular, radio network, and/or other similar type of system.

The UEs 812 may be any of a wide variety of communication devices, including wireless devices arranged, configured, and/or operable to communicate wirelessly with the network nodes 810 and other communication devices. Similarly, the network nodes 810 are arranged, capable, configured, and/or operable to communicate directly or indirectly with the UEs 812 and/or with other network nodes or equipment in the telecommunication network 802 to enable and/or provide network access, such as wireless network access, and/or to perform other functions, such as administration in the telecommunication network 802.

In the depicted example, the core network 806 connects the network nodes 810 to one or more hosts, such as host 816. These connections may be direct or indirect via one or more intermediary networks or devices. In other examples, network nodes may be directly coupled to hosts. The core network 806 includes one more core network nodes (e.g., core network node 808) that are structured with hardware and software components. Features of these components may be substantially similar to those described with respect to the UEs, network nodes, and/or hosts, such that the descriptions thereof are generally applicable to the corresponding components of the core network node 808. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 816 may be under the ownership or control of a service provider other than an operator or provider of the access network 804 and/or the telecommunication network 802, and may be operated by the service provider or on behalf of the service provider. The host 816 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 800 of FIG. 8 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 802 is a cellular network that implements 3GPP standardized features. Accordingly, the telecommunications network 802 may support network slicing to provide different logical networks to different devices that are connected to the telecommunication network 802. For example, the telecommunications network 802 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 812 are configured to transmit and/or receive information without direct human interaction. For instance, a UE may be designed to transmit information to the access network 804 on a predetermined schedule, when triggered by an internal or external event, or in response to requests from the access network 804. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 814 communicates with the access network 804 to facilitate indirect communication between one or more UEs (e.g., UE 812c and/or 812d) and network nodes (e.g., network node 810b). In some examples, the hub 814 may be a controller, router, content source and analytics, or any of the other communication devices described herein regarding UEs. For example, the hub 814 may be a broadband router enabling access to the core network 806 for the UEs. As another example, the hub 814 may be a controller that sends commands or instructions to one or more actuators in the UEs. Commands or instructions may be received from the UEs, network nodes 810, or by executable code, script, process, or other instructions in the hub 814. As another example, the hub 814 may be a data collector that acts as temporary storage for UE data and, in some embodiments, may perform analysis or other processing of the data. As another example, the hub 814 may be a content source. For example, for a UE that is a VR headset, display, loudspeaker or other media delivery device, the hub 814 may retrieve VR assets, video, audio, or other media or data related to sensory information via a network node, which the hub 814 then provides to the UE either directly, after performing local processing, and/or after adding additional local content. In still another example, the hub 814 acts as a proxy server or orchestrator for the UEs, in particular in if one or more of the UEs are low energy IoT devices.

The hub 814 may have a constant/persistent or intermittent connection to the network node 810b. The hub 814 may also allow for a different communication scheme and/or schedule between the hub 814 and UEs (e.g., UE 812c and/or 812d), and between the hub 814 and the core network 806. In other examples, the hub 814 is connected to the core network 806 and/or one or more UEs via a wired connection. Moreover, the hub 814 may be configured to connect to an M2M service provider over the access network 804 and/or to another UE over a direct connection. In some scenarios, UEs may establish a wireless connection with the network nodes 810 while still connected via the hub 814 via a wired or wireless connection. In some embodiments, the hub 814 may be a dedicated hub-that is, a hub whose primary function is to route communications to/from the UEs from/to the network node 810b. In other embodiments, the hub 814 may be a non-dedicated hub-that is, a device which is capable of operating to route communications between the UEs and network node 810b, but which is additionally capable of operating as a communication start and/or end point for certain data channels.

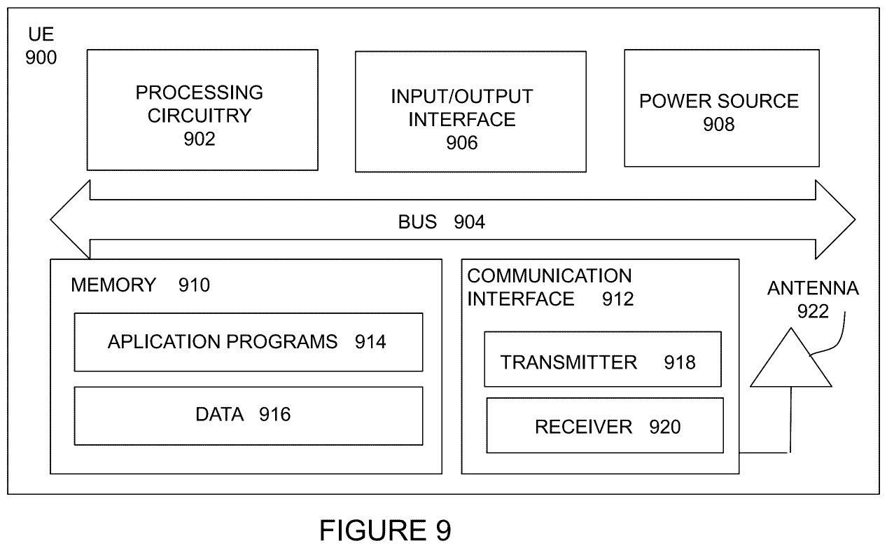

FIG. 9 shows a UE 900 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 900 includes processing circuitry 902 that is operatively coupled via a bus 904 to an input/output interface 906, a power source 908, a memory 910, a communication interface 912, and/or any other component, or any combination thereof. Certain UEs may utilize all or a subset of the components shown in FIG. 9. The level of integration between the components may vary from one UE to another UE. Further, certain UEs may contain multiple instances of a component, such as multiple processors, memories, transceivers, transmitters, receivers, etc.

The processing circuitry 902 is configured to process instructions and data and may be configured to implement any sequential state machine operative to execute instructions stored as machine-readable computer programs in the memory 910. The processing circuitry 902 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 902 may include multiple central processing units (CPUs).

In the example, the input/output interface 906 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 900. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 908 is structured as a battery or battery pack. Other types of power sources, such as an external power source (e.g., an electricity outlet), photovoltaic device, or power cell, may be used. The power source 908 may further include power circuitry for delivering power from the power source 908 itself, and/or an external power source, to the various parts of the UE 900 via input circuitry or an interface such as an electrical power cable. Delivering power may be, for example, for charging of the power source 908. Power circuitry may perform any formatting, converting, or other modification to the power from the power source 908 to make the power suitable for the respective components of the UE 900 to which power is supplied.

The memory 910 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 910 includes one or more application programs 914, such as an operating system, web browser application, a widget, gadget engine, or other application, and corresponding data 916. The memory 910 may store, for use by the UE 900, any of a variety of various operating systems or combinations of operating systems.

The memory 910 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 910 may allow the UE 900 to access instructions, application programs and the like, stored on transitory or non-transitory memory media, to off-load data, or to upload data. An article of manufacture, such as one utilizing a communication system may be tangibly embodied as or in the memory 910, which may be or comprise a device-readable storage medium.

The processing circuitry 902 may be configured to communicate with an access network or other network using the communication interface 912. The communication interface 912 may comprise one or more communication subsystems and may include or be communicatively coupled to an antenna 922. The communication interface 912 may include one or more transceivers used to communicate, such as by communicating with one or more remote transceivers of another device capable of wireless communication (e.g., another UE or a network node in an access network). Each transceiver may include a transmitter 918 and/or a receiver 920 appropriate to provide network communications (e.g., optical, electrical, frequency allocations, and so forth). Moreover, the transmitter 918 and receiver 920 may be coupled to one or more antennas (e.g., antenna 922) and may share circuit components, software or firmware, or alternatively be implemented separately.

In the illustrated embodiment, communication functions of the communication interface 912 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 912, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 900 shown in FIG. 9.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

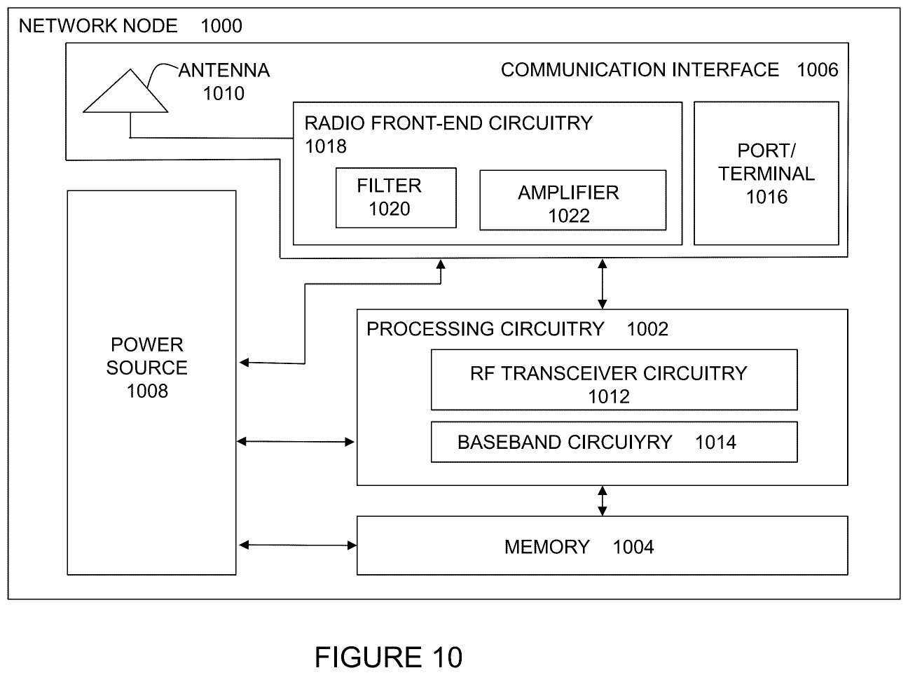

FIG. 10 shows a network node 1000 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1000 includes a processing circuitry 1002, a memory 1004, a communication interface 1006, and a power source 1008. The network node 1000 may be composed of multiple physically separate components (e.g., a NodeB component and a RNC component, or a BTS component and a BSC component, etc.), which may each have their own respective components. In certain scenarios in which the network node 1000 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1000 may be configured to support multiple radio access technologies (RATs). In such embodiments, some components may be duplicated (e.g., separate memory 1004 for different RATs) and some components may be reused (e.g., a same antenna 1010 may be shared by different RATs). The network node 1000 may also include multiple sets of the various illustrated components for different wireless technologies integrated into network node 1000, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1000.

The processing circuitry 1002 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1000 components, such as the memory 1004, to provide network node 1000 functionality.

In some embodiments, the processing circuitry 1002 includes a system on a chip (SOC). In some embodiments, the processing circuitry 1002 includes one or more of radio frequency (RF) transceiver circuitry 1012 and baseband processing circuitry 1014. In some embodiments, the radio frequency (RF) transceiver circuitry 1012 and the baseband processing circuitry 1014 may be on separate chips (or sets of chips), boards, or units, such as radio units and digital units. In alternative embodiments, part or all of RF transceiver circuitry 1012 and baseband processing circuitry 1014 may be on the same chip or set of chips, boards, or units.

The memory 1004 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1002. The memory 1004 may store any suitable instructions, data, or information, including a computer program, software, an application including one or more of logic, rules, code, tables, and/or other instructions capable of being executed by the processing circuitry 1002 and utilized by the network node 1000. The memory 1004 may be used to store any calculations made by the processing circuitry 1002 and/or any data received via the communication interface 1006. In some embodiments, the processing circuitry 1002 and memory 1004 is integrated.

The communication interface 1006 is used in wired or wireless communication of signaling and/or data between a network node, access network, and/or UE. As illustrated, the communication interface 1006 comprises port(s)/terminal(s) 1016 to send and receive data, for example to and from a network over a wired connection. The communication interface 1006 also includes radio front-end circuitry 1018 that may be coupled to, or in certain embodiments a part of, the antenna 1010. Radio front-end circuitry 1018 comprises filters 1020 and amplifiers 1022. The radio front-end circuitry 1018 may be connected to an antenna 1010 and processing circuitry 1002. The radio front-end circuitry may be configured to condition signals communicated between antenna 1010 and processing circuitry 1002. The radio front-end circuitry 1018 may receive digital data that is to be sent out to other network nodes or UEs via a wireless connection. The radio front-end circuitry 1018 may convert the digital data into a radio signal having the appropriate channel and bandwidth parameters using a combination of filters 1020 and/or amplifiers 1022. The radio signal may then be transmitted via the antenna 1010. Similarly, when receiving data, the antenna 1010 may collect radio signals which are then converted into digital data by the radio front-end circuitry 1018. The digital data may be passed to the processing circuitry 1002. In other embodiments, the communication interface may comprise different components and/or different combinations of components.

In certain alternative embodiments, the network node 1000 does not include separate radio front-end circuitry 1018, instead, the processing circuitry 1002 includes radio front-end circuitry and is connected to the antenna 1010. Similarly, in some embodiments, all or some of the RF transceiver circuitry 1012 is part of the communication interface 1006. In still other embodiments, the communication interface 1006 includes one or more ports or terminals 1016, the radio front-end circuitry 1018, and the RF transceiver circuitry 1012, as part of a radio unit (not shown), and the communication interface 1006 communicates with the baseband processing circuitry 1014, which is part of a digital unit (not shown).

The antenna 1010 may include one or more antennas, or antenna arrays, configured to send and/or receive wireless signals. The antenna 1010 may be coupled to the radio front-end circuitry 1018 and may be any type of antenna capable of transmitting and receiving data and/or signals wirelessly. In certain embodiments, the antenna 1010 is separate from the network node 1000 and connectable to the network node 1000 through an interface or port.

The antenna 1010, communication interface 1006, and/or the processing circuitry 1002 may be configured to perform any receiving operations and/or certain obtaining operations described herein as being performed by the network node. Any information, data and/or signals may be received from a UE, another network node and/or any other network equipment. Similarly, the antenna 1010, the communication interface 1006, and/or the processing circuitry 1002 may be configured to perform any transmitting operations described herein as being performed by the network node. Any information, data and/or signals may be transmitted to a UE, another network node and/or any other network equipment.

The power source 1008 provides power to the various components of network node 1000 in a form suitable for the respective components (e.g., at a voltage and current level needed for each respective component). The power source 1008 may further comprise, or be coupled to, power management circuitry to supply the components of the network node 1000 with power for performing the functionality described herein. For example, the network node 1000 may be connectable to an external power source (e.g., the power grid, an electricity outlet) via an input circuitry or interface such as an electrical cable, whereby the external power source supplies power to power circuitry of the power source 1008. As a further example, the power source 1008 may comprise a source of power in the form of a battery or battery pack which is connected to, or integrated in, power circuitry. The battery may provide backup power should the external power source fail.

Embodiments of the network node 1000 may include additional components beyond those shown in FIG. 10 for providing certain aspects of the network node's functionality, including any of the functionality described herein and/or any functionality necessary to support the subject matter described herein. For example, the network node 1000 may include user interface equipment to allow input of information into the network node 1000 and to allow output of information from the network node 1000. This may allow a user to perform diagnostic, maintenance, repair, and other administrative functions for the network node 1000.

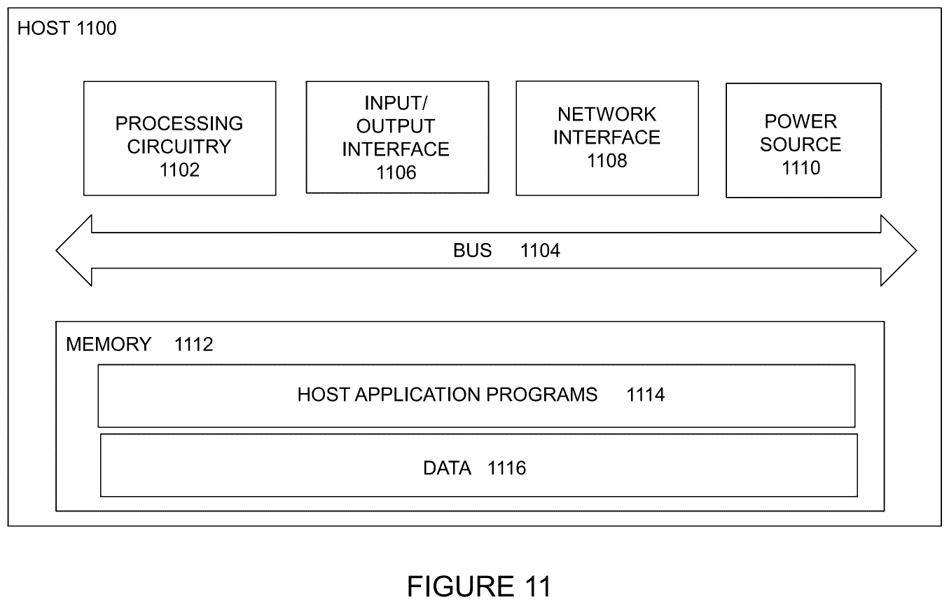

FIG. 11 is a block diagram of a host 1100, which may be an embodiment of the host 816 of FIG. 8, in accordance with various aspects described herein. As used herein, the host 1100 may be or comprise various combinations hardware and/or software, including a standalone server, a blade server, a cloud-implemented server, a distributed server, a virtual machine, container, or processing resources in a server farm. The host 1100 may provide one or more services to one or more UEs.

The host 1100 includes processing circuitry 1102 that is operatively coupled via a bus 1104 to an input/output interface 1106, a network interface 1108, a power source 1110, and a memory 1112. Other components may be included in other embodiments. Features of these components may be substantially similar to those described with respect to the devices of previous figures, such as FIGS. 9 and 10, such that the descriptions thereof are generally applicable to the corresponding components of host 1100.

The memory 1112 may include one or more computer programs including one or more host application programs 1114 and data 1116, which may include user data, e.g., data generated by a UE for the host 1100 or data generated by the host 1100 for a UE. Embodiments of the host 1100 may utilize only a subset or all of the components shown. The host application programs 1114 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1114 may also provide for user authentication and licensing checks and may periodically report health, routes, and content availability to a central node, such as a device in or on the edge of a core network. Accordingly, the host 1100 may select and/or indicate a different host for over-the-top services for a UE. The host application programs 1114 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

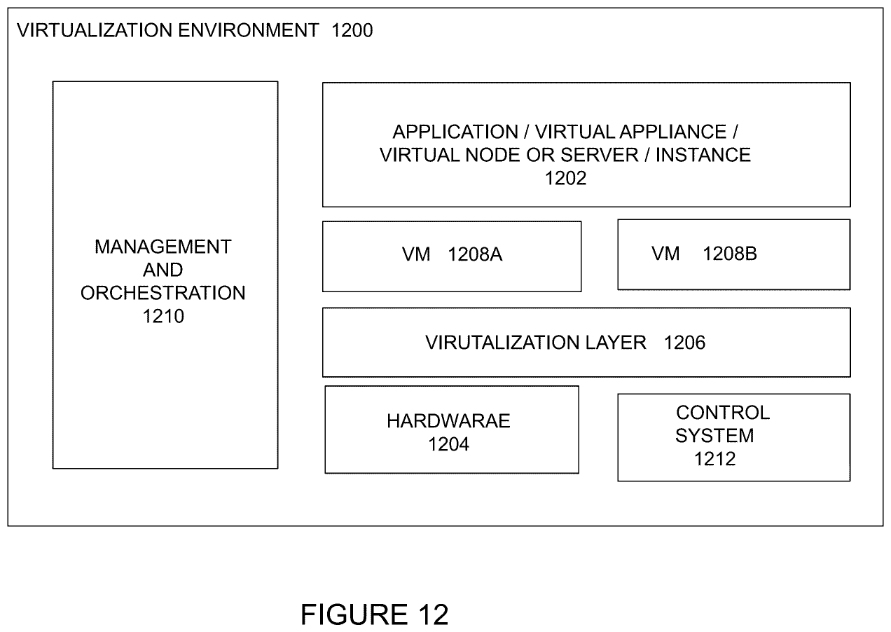

FIG. 12 is a block diagram illustrating a virtualization environment 1200 in which functions implemented by some embodiments may be virtualized.

In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1200 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1202 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1204 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1206 (also referred to as hypervisors or virtual machine monitors (VMMs)), provide VMs 1208a and 1208b (one or more of which may be generally referred to as VMs 1208), and/or perform any of the functions, features and/or benefits described in relation with some embodiments described herein. The virtualization layer 1206 may present a virtual operating platform that appears like networking hardware to the VMs 1208.

The VMs 1208 comprise virtual processing, virtual memory, virtual networking or interface and virtual storage, and may be run by a corresponding virtualization layer 1206. Different embodiments of the instance of a virtual appliance 1202 may be implemented on one or more of VMs 1208, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1208 may be a software implementation of a physical machine that runs programs as if they were executing on a physical, non-virtualized machine. Each of the VMs 1208, and that part of hardware 1204 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1208 on top of the hardware 1204 and corresponds to the application 1202.

Hardware 1204 may be implemented in a standalone network node with generic or specific components. Hardware 1204 may implement some functions via virtualization. Alternatively, hardware 1204 may be part of a larger cluster of hardware (e.g. such as in a data center or CPE) where many hardware nodes work together and are managed via management and orchestration 1210, which, among others, oversees lifecycle management of applications 1202. In some embodiments, hardware 1204 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1212 which may alternatively be used for communication between hardware nodes and radio units.

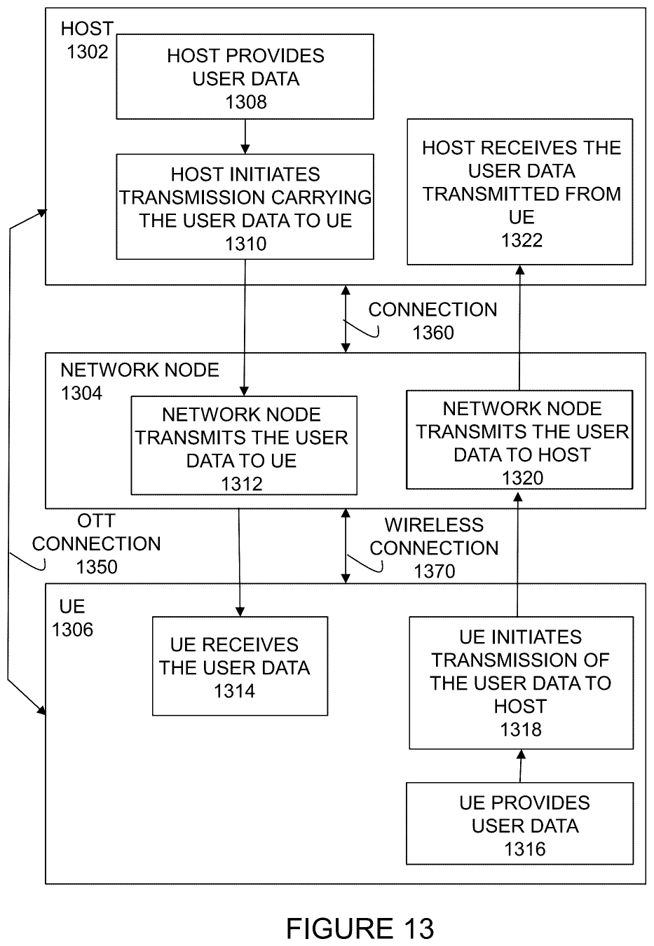

FIG. 13 shows a communication diagram of a host 1302 communicating via a network node 1304 with a UE 1306 over a partially wireless connection in accordance with some embodiments.

Example implementations, in accordance with various embodiments, of the UE (such as a UE 812a of FIG. 8 and/or UE 900 of FIG. 9), network node (such as network node 810a of FIG. 8 and/or network node 1000 of FIG. 10), and host (such as host 816 of FIG. 8 and/or host 1100 of FIG. 11) discussed in the preceding paragraphs will now be described with reference to FIG. 13.

Like host 1100, embodiments of host 1302 include hardware, such as a communication interface, processing circuitry, and memory. The host 1302 also includes software, which is stored in or accessible by the host 1302 and executable by the processing circuitry. The software includes a host application that may be operable to provide a service to a remote user, such as the UE 1306 connecting via an over-the-top (OTT) connection 1350 extending between the UE 1306 and host 1302. In providing the service to the remote user, a host application may provide user data which is transmitted using the OTT connection 1350.

The network node 1304 includes hardware enabling it to communicate with the host 1302 and UE 1306. The connection 1360 may be direct or pass through a core network (like core network 806 of FIG. 8) and/or one or more other intermediate networks, such as one or more public, private, or hosted networks. For example, an intermediate network may be a backbone network or the Internet.

The UE 1306 includes hardware and software, which is stored in or accessible by UE 1306 and executable by the UE's processing circuitry. The software includes a client application, such as a web browser or operator-specific “app” that may be operable to provide a service to a human or non-human user via UE 1306 with the support of the host 1302. In the host 1302, an executing host application may communicate with the executing client application via the OTT connection 1350 terminating at the UE 1306 and host 1302. In providing the service to the user, the UE's client application may receive request data from the host's host application and provide user data in response to the request data. The OTT connection 1350 may transfer both the request data and the user data. The UE's client application may interact with the user to generate the user data that it provides to the host application through the OTT connection 1350.

The OTT connection 1350 may extend via a connection 1360 between the host 1302 and the network node 1304 and via a wireless connection 1370 between the network node 1304 and the UE 1306 to provide the connection between the host 1302 and the UE 1306. The connection 1360 and wireless connection 1370, over which the OTT connection 1350 may be provided, have been drawn abstractly to illustrate the communication between the host 1302 and the UE 1306 via the network node 1304, without explicit reference to any intermediary devices and the precise routing of messages via these devices.

As an example of transmitting data via the OTT connection 1350, in step 1308, the host 1302 provides user data, which may be performed by executing a host application. In some embodiments, the user data is associated with a particular human user interacting with the UE 1306. In other embodiments, the user data is associated with a UE 1306 that shares data with the host 1302 without explicit human interaction. In step 1310, the host 1302 initiates a transmission carrying the user data towards the UE 1306. The host 1302 may initiate the transmission responsive to a request transmitted by the UE 1306. The request may be caused by human interaction with the UE 1306 or by operation of the client application executing on the UE 1306. The transmission may pass via the network node 1304, in accordance with the teachings of the embodiments described throughout this disclosure. Accordingly, in step 1312, the network node 1304 transmits to the UE 1306 the user data that was carried in the transmission that the host 1302 initiated, in accordance with the teachings of the embodiments described throughout this disclosure. In step 1314, the UE 1306 receives the user data carried in the transmission, which may be performed by a client application executed on the UE 1306 associated with the host application executed by the host 1302.

In some examples, the UE 1306 executes a client application which provides user data to the host 1302. The user data may be provided in reaction or response to the data received from the host 1302. Accordingly, in step 1316, the UE 1306 may provide user data, which may be performed by executing the client application. In providing the user data, the client application may further consider user input received from the user via an input/output interface of the UE 1306. Regardless of the specific manner in which the user data was provided, the UE 1306 initiates, in step 1318, transmission of the user data towards the host 1302 via the network node 1304. In step 1320, in accordance with the teachings of the embodiments described throughout this disclosure, the network node 1304 receives user data from the UE 1306 and initiates transmission of the received user data towards the host 1302. In step 1322, the host 1302 receives the user data carried in the transmission initiated by the UE 1306.

One or more of the various embodiments improve the performance of OTT services provided to the UE 1306 using the OTT connection 1350, in which the wireless connection 1370 forms the last segment. More precisely, the teachings of these embodiments may improve one or more of, for example, data rate, latency, and/or power consumption and, thereby, provide benefits such as, for example, reduced user waiting time, relaxed restriction on file size, improved content resolution, better responsiveness, and/or extended battery lifetime.

In an example scenario, factory status information may be collected and analyzed by the host 1302. As another example, the host 1302 may process audio and video data which may have been retrieved from a UE for use in creating maps. As another example, the host 1302 may collect and analyze real-time data to assist in controlling vehicle congestion (e.g., controlling traffic lights). As another example, the host 1302 may store surveillance video uploaded by a UE. As another example, the host 1302 may store or control access to media content such as video, audio, VR or AR which it can broadcast, multicast or unicast to UEs. As other examples, the host 1302 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1350 between the host 1302 and UE 1306, in response to variations in the measurement results. The measurement procedure and/or the network functionality for reconfiguring the OTT connection may be implemented in software and hardware of the host 1302 and/or UE 1306. In some embodiments, sensors (not shown) may be deployed in or in association with other devices through which the OTT connection 1350 passes; the sensors may participate in the measurement procedure by supplying values of the monitored quantities exemplified above, or supplying values of other physical quantities from which software may compute or estimate the monitored quantities. The reconfiguring of the OTT connection 1350 may include message format, retransmission settings, preferred routing etc.; the reconfiguring need not directly alter the operation of the network node 1304. Such procedures and functionalities may be known and practiced in the art. In certain embodiments, measurements may involve proprietary UE signaling that facilitates measurements of throughput, propagation times, latency and the like, by the host 1302. The measurements may be implemented in that software causes messages to be transmitted, in particular empty or ‘dummy’ messages, using the OTT connection 1350 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

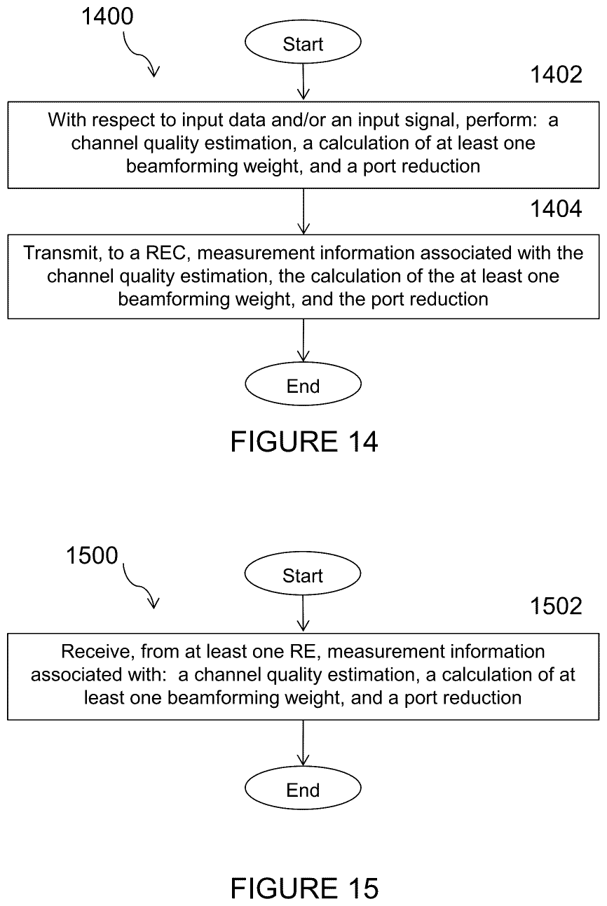

FIG. 14 illustrates a method 1400 by at least one RE of a network node, according to certain embodiments. At step 1402, with respect to input data and/or an input signal, The RE performs a channel quality estimation, a calculation of at least one BFW, and a port reduction. At step 1404, the RE transmits, to a REC, measurement information associated with the channel quality estimation, the calculation of the at least one BFW, and the port reduction.

In a particular embodiment, the REC comprises an O-DU, and the RE comprises an O-RU.

In a particular embodiment, the at least one RE performs at least one measurement during the performance of the channel quality estimation, the calculation of at least one beamforming weight, and the port reduction. The measurement information is based on performing the at least one measurement.

In a particular embodiment, the at least one measurement includes at least SNIR measurement, and the measurement information includes at least one value associated with the at least one SNIR measurement.

In a particular embodiment, the at least one measurement comprises a plurality of SNIR measurements, and each SNIR measurement is associated with at least one of a frequency resolution and a time resolution.

In a particular embodiment, the at least one measurement comprises at least one beta-based SNIR measurement, and the measurement information comprises at least one value associated with the at least one beta-based SNIR measurement.

In a particular embodiment, the at least one measurement includes at least one IpN measurement, and the measurement information comprises at least one value associated with the at least one IpN measurement.

In a particular embodiment, the at least one measurement includes a plurality of IpN measurements, and each IpN measurement is associated with at least one of a frequency resolution and a time resolution.

In a particular embodiment, the at least one measurement includes at least one TA measurement, and the measurement information comprises at least one value associated with the at least one TA measurement.

In a particular embodiment, the at least one measurement comprises a plurality of TA measurements, and each TA measurement is associated with a respective one of a plurality of UEs.

In a particular embodiment, the at least one measurement includes at least one Frequency Offset measurement, and the measurement information includes at least one value associated with the at least one Frequency Offset measurement.

In a particular embodiment, the at least one measurement comprises a plurality of Frequency Offset measurements, and each Frequency Offset measurement is associated with a respective one of a plurality of UEs.

In a particular embodiment, the at least one measurement comprises a plurality of Frequency Offset measurements, and each Frequency Offset measurement is associated with a respective one of a plurality of carriers.

In a particular embodiment, the RE performs at least one of: an equalizing operation, and a calculation of at least one equalization weight.

In a particular embodiment, the measurement information is transmitted with at least one IQ-data streams. The number of IQ-data streams is equal to the number of layers, and a layer corresponds to a stream of information bits transmitted from the RE to the REC.

In a particular embodiment, when performing the channel quality estimation, the RE extracts at least one DMRS from an input signal or input data and performs DMRS channel estimation on the at least one DMRS.

In a particular embodiment, the RE receives, from the REC, the control information, and the control information includes at least one of: scheduling information for at least one user equipment, and information indicating at least one reference signal transmitted by the at least one user equipment.

FIG. 15 illustrates a method 1500 by at least one REC of a network node, according to certain embodiments. At step 1502, the REC receives, from at least one RE, measurement information associated with a channel quality estimation, a calculation of at least one BFW, and a port reduction.

In a particular embodiment, the REC uses the measurement information to perform demodulation and/or decoding.

In a particular embodiment, the REC uses the measurement information to generate information and/or messages to be sent to the UE via the RE.

In a particular embodiment, the RE includes an O-RU, and the REC includes an O-DU.

In a particular embodiment, the measurement information is based on at least one measurement performed by the RE.

In a particular embodiment, the measurement information includes at least one value associated with at least one SNIR measurement performed by the RE.

In a particular embodiment, the at least one value comprises a plurality of SNIR values associated with a plurality of SNIR measurements performed by the RE, and each SNIR value and/or each SNIR measurement is associated with a at least one of a frequency resolution and a time resolution.

In a particular embodiment, the measurement information includes at least one value associated with at least one beta-based SNIR measurement performed by the RE.

In a particular embodiment, the measurement information includes at least one value associated with at least one IpN measurement performed by the RE.

In a particular embodiment, the at least one value includes a plurality of IpN values, and each IpN value and/or IpN measurement is associated with at least one of a frequency resolution and a time resolution.

In a particular embodiment, the measurement information includes at least one value associated with at least one TA measurement performed by the RE.

In a particular embodiment, the at least one value includes a plurality of TA values, and each TA measurement and/or each TA value is associated with a respective one of a plurality of UEs.

In a particular embodiment, the measurement information comprises at least one value associated with at least one Frequency Offset measurement performed by the RE.

In a particular embodiment, the at least one value includes a plurality of Frequency Offset values, and each Frequency Offset measurement and/or each Frequency Offset value is associated with a respective one of a plurality of UEs.

In a particular embodiment, each Frequency Offset measurement is associated with a respective one of a plurality of carriers.

In a particular embodiment, the measurement information is transmitted with at least one IQ-data stream. The number of IQ-data streams is equal to the number of layers, and a layer corresponds to a stream of information bits received from the RE.

In a particular embodiment, the REC transmits, to the RE, control information. The control information includes at least one of: scheduling information for at least one UE and information indicating at least one reference signal transmitted by the at least one UE.

### EXAMPLE EMBODIMENTS

### Group A Example Embodiments

Example Embodiment A1. A method by a user equipment for performing channel estimation and/or equalization, the method comprising: any of the user equipment steps, features, or functions described above, either alone or in combination with other steps, features, or functions described above.

Example Embodiment A2. The method of the previous embodiment, further comprising one or more additional user equipment steps, features or functions described above.

Example Embodiment A3. The method of any of the previous embodiments, further comprising: providing user data; and forwarding the user data to a host computer via the transmission to the network node.

### Group B Example Embodiments

Example Embodiment B1. A method performed by a network node for [insert purpose], the method comprising: any of the network node steps, features, or functions described above, either alone or in combination with other steps, features, or functions described above.

Example Embodiment B2. The method of the previous embodiment, further comprising one or more additional network node steps, features or functions described above.

Example Embodiment B3. The method of any of the previous embodiments, further comprising: obtaining user data; and forwarding the user data to a host or a user equipment.

### Group C Example Embodiments

Example Embodiment C1. A method by a network node comprising: with respect to input data and/or an input signal, performing, by at least one radio equipment (RE), and at least one of: a channel quality estimation, a calculation of at least one beamforming weight, a port reduction, a calculation of at least one equalization weight, a demodulation, and a decoding; and transmitting, from the RE to a radio equipment controller (REC), measurement information associated with the channel quality estimation, the calculation of the at least one beamforming weight, the calculation of the at least one equalization weight, the port reduction, the demodulation, and/or the decoding of the input data and/or input signal.

Example Embodiment C2. The method of Example Embodiment C1, wherein the measurement information is transmitted with at least one In-phase and Quadrature data (IQ-data) streams.

Example Embodiment C3. The method of Example Embodiment C2, wherein a number of IQ-data streams is equal to a number of layers, and wherein a layer corresponds to a stream of information bits transmitted (i.e., output) from the RE to the REC.

Example Embodiments C4. The method of any one of Example Embodiments C2 to C3, wherein the IQ-data comprises equalized user data.

Example Embodiment C5. The method of any one of Example Embodiments C1 to C4, wherein the measurement information is real-time and/or instantaneous information.

Example Embodiment C6. The method of any one of Example Embodiments C1 to C5, wherein the REC comprises an O-RAN distributed unit (O-DU) and the RE comprises an O-RAN radio unit (O-RU).

Example Embodiment C7. The method of any one of Example Embodiments C1 to C6, wherein performing the demodulation comprises: extracting at least one demodulation reference signal (DMRS) from an input signal and/or input data; and performing DMRS channel estimation on the at least one DMRS.

Example Embodiment C8. The method of any one of Example Embodiments C1 to C7, further comprising: performing at least one measurement during the performance of the channel quality estimation, the calculation of at least one beamforming weight, the port reduction, the calculation of at least one equalization weight, the demodulation, and/or the decoding of the input data and/or the input signal, and wherein the measurement information is based on performing the at least one measurement.

Example Embodiment C9. The method of Example Embodiment C8, wherein the at least one measurement comprises at least one signal-to-noise/interference-ratio (SNIR) measurement and the measurement information comprises at least one value associated the at least one SNIR

Example Embodiment C10. The method of Example Embodiment C9, wherein the at least one measurement comprises a plurality of SNIR measurements, each SNIR measurement being associated with a respective frequency resolution and/or time resolution.

Example Embodiment C11. The method of any one of Example Embodiments C8 to C10, wherein the at least one measurement comprises at least one beta-based SNIR measurement and the measurement information comprises at least one value associated the at least one beta-based SNIR measurement.

Example Embodiment C12. The method of any one of Example Embodiments C8 to C11, wherein the at least one measurement comprises at least one Interference-plus-Noise (IpN) measurement and the measurement information comprises at least one value associated the at least one IpN measurement.

Example Embodiment C13. The method of Example Embodiment C12, wherein the at least one measurement comprises a plurality of IpN measurements, each IpN measurement being associated with a respective frequency resolution and/or time resolution.

Example Embodiment C14. The method of any one of Example Embodiments C8 to C13, wherein the at least one measurement comprises at least one Timing Advance (TA) measurement and the measurement information comprises at least one value associated the at least one TA measurement.

Example Embodiment C15. The method of Example Embodiment C14, wherein the at least one measurement comprises a plurality of TA measurements, each TA measurement being associated with a respective one of a plurality of user equipments (UEs).

Example Embodiment C16. The method of any one of Example Embodiments C8 to C15, wherein the at least one measurement comprises at least one Frequency Offset measurement and the measurement information comprises at least one value associated the at least one Frequency Offset measurement.

Example Embodiment C17. The method of Example Embodiment C16, wherein the at least one measurement comprises a plurality of Frequency Offset measurements, each Frequency Offset measurement being associated with a respective one of a plurality of user equipments (UEs).

Example Embodiment C18. The method of any one of Example Embodiments C16 to C17, wherein the at least one measurement comprises a plurality of Frequency Offset measurements, each Frequency Offset measurement being associated with a respective one of a plurality of carriers.

Example Embodiment C19. The method of any one of Example Embodiments C1 to C18, further comprising: transmitting, from the REC to the RE, control information; and/or receiving, from the REC by the RE, the control information.

Example Embodiment C20. The method of Example Embodiment C19, wherein the control information is received by at least one of: an equalizer of the RE, a beamforming weight calculator of the RE, a DMRS channel estimator, a DMRS extractor, and/or a PUSCH extractor.

Example Embodiment C21. The method of any one of Example Embodiments C19 to C20, wherein the control information comprises at least one of: scheduling information for at least one user equipment, and information indicating at least one reference signal transmitted by the at least one user equipment.

Example Embodiment C22. The method of any one of Example Embodiments C19 to C21, wherein the RE uses the control information to perform the at least one of the channel quality estimation, the calculation of at least one beamforming weight, the port reduction, the calculation of at least one equalization weight, the demodulation, and the decoding.

Example Embodiment C23. The method of any one of Example Embodiments C1 to C22, wherein the REC and the RE are components of the network node.

Example Embodiment C24. The method of Example Embodiment C23, wherein the network node is operating as an access node and the at least one RE communicates with at least one user equipment (UE).

Example Embodiment C25. The method of any one of Example Embodiments C1 to C24, wherein the network node comprises a gNodeB (gNB).

Example Embodiment C26. The method of any of the previous Example Embodiments, further comprising: obtaining user data; and forwarding the user data to a host or a user equipment.

Example Embodiment C27.A network node comprising processing circuitry configured to perform any of the methods of Example Embodiments C1 to C26.

Example Embodiment C28. A computer program comprising instructions which when executed on a computer perform any of the methods of Example Embodiments C1 to C26.

Example Embodiment C29. A computer program product comprising computer program, the computer program comprising instructions which when executed on a computer perform any of the methods of Example Embodiments C1 to C26.

Example Embodiment C30. A non-transitory computer readable medium storing instructions which when executed by a computer perform any of the methods of Example Embodiments C1 to C26.

### Group D Example Embodiments

Example Embodiment D1. A method by at least one radio equipment (RE) of a network node comprising: with respect to input data and/or an input signal, performing at least one of: a channel quality estimation, a calculation of at least one beamforming weight, a port reduction, a calculation of at least one equalization weight, a demodulation, and a decoding; and transmitting, to a radio equipment controller (REC), measurement information associated with the channel quality estimation, the calculation of the at least one beamforming weight, the calculation of the at least one equalization weight, the port reduction, the demodulation, and/or the decoding of the input data and/or input signal.

Example Embodiment D2. The method of Example Embodiment D1, wherein the measurement information is transmitted with at least one In-phase and Quadrature data (IQ-data) streams.

Example Embodiment D3. The method of Example Embodiment D2, wherein a number of IQ-data streams is equal to a number of layers, and wherein a layer corresponds to a stream of information bits transmitted (i.e., output) from the RE to the REC.

Example Embodiments D4. The method of any one of Example Embodiments D2 to D3, wherein the IQ-data comprises equalized user data.

Example Embodiment D5. The method of any one of Example Embodiments D1 to D4, wherein the measurement information is real-time and/or instantaneous information.

Example Embodiment D6. The method of any one of Example Embodiments D1 to D5, wherein the REC comprises an O-RAN distributed unit (O-DU) and the RE comprises an O-RAN radio unit (O-RU).

Example Embodiment D7. The method of any one of Example Embodiments D1 to D6, wherein performing the demodulation comprises: extracting at least one demodulation reference signal (DMRS) from an input signal and/or input data; and performing DMRS channel estimation on the at least one DMRS.

Example Embodiment D8. The method of any one of Example Embodiments D1 to D7, further comprising: performing at least one measurement during the performance of the channel quality estimation, the calculation of at least one beamforming weight, the port reduction, the calculation of at least one equalization weight, the demodulation, and/or the decoding of the input data and/or the input signal, and wherein the measurement information is based on performing the at least one measurement.

Example Embodiment D9. The method of Example Embodiment D8, wherein the at least one measurement comprises at least one signal-to-noise/interference-ratio (SNIR) measurement and the measurement information comprises at least one value associated the at least one SNIR

Example Embodiment D10. The method of Example Embodiment D9, wherein the at least one measurement comprises a plurality of SNIR measurements, each SNIR measurement being associated with a respective frequency resolution and/or time resolution.

Example Embodiment D11. The method of any one of Example Embodiments D8 to D10, wherein the at least one measurement comprises at least one beta-based SNIR measurement and the measurement information comprises at least one value associated the at least one beta-based SNIR measurement.

Example Embodiment D12. The method of any one of Example Embodiments D8 to D11, wherein the at least one measurement comprises at least one Interference-plus-Noise (IpN) measurement and the measurement information comprises at least one value associated the at least one IpN measurement.

Example Embodiment D13. The method of Example Embodiment D12, wherein the at least one measurement comprises a plurality of IpN measurements, each IpN measurement being associated with a respective frequency resolution and/or time resolution.

Example Embodiment D14. The method of any one of Example Embodiments D8 to D13, wherein the at least one measurement comprises at least one Timing Advance (TA) measurement and the measurement information comprises at least one value associated the at least one TA measurement.

Example Embodiment D15. The method of Example Embodiment D14, wherein the at least one measurement comprises a plurality of TA measurements, each TA measurement being associated with a respective one of a plurality of user equipments (UEs).

Example Embodiment D16. The method of any one of Example Embodiments D8 to D15, wherein the at least one measurement comprises at least one Frequency Offset measurement and the measurement information comprises at least one value associated the at least one Frequency Offset measurement.

Example Embodiment D17. The method of Example Embodiment D16, wherein the at least one measurement comprises a plurality of Frequency Offset measurements, each Frequency Offset measurement being associated with a respective one of a plurality of user equipments (UEs).

Example Embodiment D18. The method of any one of Example Embodiments D16 to D17, wherein the at least one measurement comprises a plurality of Frequency Offset measurements, each Frequency Offset measurement being associated with a respective one of a plurality of carriers.

Example Embodiment D19. The method of any one of Example Embodiments D1 to D18, further comprising receiving, from the REC, control information.

Example Embodiment D20. The method of Example Embodiment D19, wherein the control information is received by at least one of: an equalizer of the RE, a beamforming weight calculator of the RE, a DMRS channel estimator, a DMRS extractor, and/or a PUSCH extractor.

Example Embodiment D21. The method of any one of Example Embodiments D19 to D20, wherein the control information comprises at least one of: scheduling information for at least one user equipment, and information indicating at least one reference signal transmitted by the at least one user equipment.

Example Embodiment D22. The method of any one of Example Embodiments D19 to D21, wherein the RE uses the control information to perform the at least one of the channel quality estimation, the calculation of at least one beamforming weight, the port reduction, the calculation of at least one equalization weight, the demodulation, and the decoding.

Example Embodiment D23. The method of any one of Example Embodiments D1 to D22, wherein the REC and the RE are components of the network node.

Example Embodiment D24. The method of Example Embodiment D23, wherein the network node is operating as an access node and the at least one RE communicates with at least one user equipment (UE).

Example Embodiment D25. The method of any one of Example Embodiments D1 to D24, wherein the network node comprises a gNodeB (gNB).

Example Embodiment D26. The method of any of the previous Example Embodiments, further comprising: obtaining user data; and forwarding the user data to a host or a user equipment.

Example Embodiment D27. A network node comprising processing circuitry configured to perform any of the methods of Example Embodiments D1 to D26.

Example Embodiment D28. A computer program comprising instructions which when executed on a computer perform any of the methods of Example Embodiments D1 to D26.

Example Embodiment D29. A computer program product comprising computer program, the computer program comprising instructions which when executed on a computer perform any of the methods of Example Embodiments D1 to D26.

Example Embodiment D30. A non-transitory computer readable medium storing instructions which when executed by a computer perform any of the methods of Example Embodiments D1 to D26.

### Group E Example Embodiments

Example Embodiment E1. A method by at least one radio equipment controller (REC) of a network node comprising: receiving, from at least one radio equipment (RE), measurement information, the measurement information associated with at least one of: a channel quality estimation performed by the RE, a calculation of at least one beamforming weight by the RE, a calculation of at least one equalization weight by the RE, a port reduction by the RE, a demodulation performed by the RE, and/or a decoding of input data and/or an input signal by the RE.

Example Embodiment E2. The method of Example Embodiment E1, wherein the measurement information is transmitted with at least one In-phase and Quadrature data (IQ-data) streams.

Example Embodiment E3. The method of Example Embodiment E2, wherein a number of IQ-data streams is equal to a number of layers, and wherein a layer corresponds to a stream of information bits received (i.e., output) from the RE.

Example Embodiments E4. The method of any one of Example Embodiments E2 to E3, wherein the IQ-data comprises equalized user data.

Example Embodiment E5. The method of any one of Example Embodiments E1 to E4, wherein the measurement information is real-time and/or instantaneous information.

Example Embodiment E6. The method of any one of Example Embodiments E1 to E5, wherein the REC comprises an O-RAN distributed unit (O-DU) and the RE comprises an O-RAN radio unit (O-RU).

Example Embodiment E7. The method of any one of Example Embodiments E1 to E6, wherein the measurement information is based on at least one measurement performed by the RE.

Example Embodiment E8. The method of Example Embodiment E7, wherein the measurement information comprises at least one value associated at least one signal-to-noise/interference-ratio (SNIR) measurement performed by the RE.

Example Embodiment E9. The method of Example Embodiment E8, wherein the at least one value comprises a plurality of SNIR values associated with a plurality of SNIR measurements performed by the RE, each SNIR value and/or each SNIR measurement being associated with a respective frequency resolution and/or time resolution.

Example Embodiment E10. The method of any one of Example Embodiments E7 to E9, wherein the measurement information comprises at least one value associated with at least one beta-based SNIR measurement performed by the RE.

Example Embodiment E11. The method of any one of Example Embodiments E7 to E10, wherein the measurement information comprises at least one value associated with at least one Interference-plus-Noise (IpN) measurement performed by the RE.

Example Embodiment E12. The method of Example Embodiment E11, wherein the at least one value comprises a plurality of IpN values, each IpN value and/or IpN measurement being associated with a respective frequency resolution and/or time resolution.

Example Embodiment E13. The method of any one of Example Embodiments E7 to E12, wherein the measurement information comprises at least one value associated with at least one Timing Advance (TA) measurement performed by the RE.

Example Embodiment E14. The method of Example Embodiment D13, wherein the at least one value comprises a plurality of TA values, each TA measurement and/or each TA value being associated with a respective one of a plurality of user equipments (UEs).

Example Embodiment E15. The method of any one of Example Embodiments E7 to E14, wherein the measurement information comprises at least one value associated with at least one Frequency Offset measurement performed by the RE.

Example Embodiment E16. The method of Example Embodiment E15, wherein the at least one value comprises a plurality of Frequency Offset values, each Frequency Offset measurement and/or each Frequency Offset value being associated with a respective one of a plurality of user equipments (UEs).

Example Embodiment E17. The method of any one of Example Embodiments E15 to E16, wherein each Frequency Offset measurement is associated with a respective one of a plurality of carriers.

Example Embodiment E18. The method of any one of Example Embodiments E1 to E17, further comprising transmitting, to the RE, control information.

Example Embodiment E19. The method of Example Embodiment E18, wherein the control information is transmitted to at least one of: an equalizer of the RE, a beamforming weight calculator of the RE, a DMRS channel estimator, a DMRS extractor, and/or a PUSCH extractor.

Example Embodiment E20. The method of any one of Example Embodiments E18 to E19, wherein the control information comprises at least one of: scheduling information for at least one user equipment, and information indicating at least one reference signal transmitted by the at least one user equipment.

Example Embodiment E21. The method of any one of Example Embodiments E1 to E20, wherein the REC and the RE are components of the network node.

Example Embodiment E22. The method of Example Embodiment D21, wherein the network node is operating as an access node and the at least one RE communicates with at least one user equipment (UE).

Example Embodiment E23. The method of any one of Example Embodiments E1 to E22, wherein the network node comprises a gNodeB (gNB).

Example Embodiment E24. The method of any of the previous Example Embodiments, further comprising: obtaining user data; and forwarding the user data to a host or a user equipment.

Example Embodiment E25. A network node comprising processing circuitry configured to perform any of the methods of Example Embodiments E1 to E24.

Example Embodiment E26. A computer program comprising instructions which when executed on a computer perform any of the methods of Example Embodiments E1 to E24.

Example Embodiment E27. A computer program product comprising computer program, the computer program comprising instructions which when executed on a computer perform any of the methods of Example Embodiments E1 to E24.

Example Embodiment E28. A non-transitory computer readable medium storing instructions which when executed by a computer perform any of the methods of Example Embodiments E1 to E24.

### Group F Example Embodiments

Example Embodiment F1. A user equipment comprising: processing circuitry configured to perform any of the steps of any of the Group A Example Embodiments; and power supply circuitry configured to supply power to the processing circuitry.

Example Embodiment F2. A network node comprising: processing circuitry configured to perform any of the steps of any of the Group B, C, D, and E Example Embodiments; power supply circuitry configured to supply power to the processing circuitry.

Example Embodiment F3. A user equipment (UE) comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A Example Embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Example Embodiment F4. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A Example Embodiments to receive the user data from the host.

Example Embodiment F5. The host of the previous Example Embodiment, wherein the cellular network further includes a network node configured to communicate with the UE to transmit the user data to the UE from the host.

Example Embodiment F6. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment F7. A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.

Example Embodiment F8. The method of the previous Example Embodiment, further comprising: at the host, executing a host application associated with a client application executing on the UE to receive the user data from the UE.

Example Embodiment F9. The method of the previous Example Embodiment, further comprising: at the host, transmitting input data to the client application executing on the UE, the input data being provided by executing the host application, wherein the user data is provided by the client application in response to the input data from the host application.

Example Embodiment F10. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A Example Embodiments to transmit the user data to the host.

Example Embodiment F11. The host of the previous Example Embodiment, wherein the cellular network further includes a network node configured to communicate with the UE to transmit the user data from the UE to the host.

Example Embodiment F12. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment F13. A method implemented by a host configured to operate in a communication system that further includes a network node and a user equipment (UE), the method comprising: at the host, receiving user data transmitted to the host via the network node by the UE, wherein the UE performs any of the steps of any of the Group A Example Embodiments to transmit the user data to the host.

Example Embodiment F14. The method of the previous Example Embodiment, further comprising: at the host, executing a host application associated with a client application executing on the UE to receive the user data from the UE.

Example Embodiment F15. The method of the previous Example Embodiment, further comprising: at the host, transmitting input data to the client application executing on the UE, the input data being provided by executing the host application, wherein the user data is provided by the client application in response to the input data from the host application.

Example Embodiment F16. A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B, C, D, and E Example Embodiments to transmit the user data from the host to the UE.

Example Embodiment F17. The host of the previous Example Embodiment, wherein: the processing circuitry of the host is configured to execute a host application that provides the user data; and the UE comprises processing circuitry configured to execute a client application associated with the host application to receive the transmission of user data from the host.

Example Embodiment F18. A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B, C, D, and E Example Embodiments to transmit the user data from the host to the UE.

Example Embodiment F19. The method of the previous Example Embodiment, further comprising, at the network node, transmitting the user data provided by the host for the UE.

Example Embodiment F20. The method of any of the previous 2 Example Embodiments, wherein the user data is provided at the host by executing a host application that interacts with a client application executing on the UE, the client application being associated with the host application.

Example Embodiment F21. A communication system configured to provide an over-the-top service, the communication system comprising: a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B, C, D, and E Example Embodiments to transmit the user data from the host to the UE.

Example Embodiment F22. The communication system of the previous Example Embodiment, further comprising: the network node; and/or the user equipment.

Example Embodiment F23. A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B, C, D, and E Example Embodiments to receive the user data from a user equipment (UE) for the host.

Example Embodiment F24. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment F25. The host of the any of the previous 2 Example Embodiments, wherein the initiating receipt of the user data comprises requesting the user data.

Example Embodiment F26. A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B, C, D, and E Example Embodiments to receive the user data from the UE for the host.

Example Embodiment F27. The method of the previous Example Embodiment, further comprising at the network node, transmitting the received user data to the host.

1-38. (canceled)

39. A method by at least one radio equipment, RE, of a network node comprising:
with respect to input data and/or an input signal, performing:
a channel quality estimation,
a calculation of at least one beamforming weight, and
a port reduction; and
transmitting, to a radio equipment controller, REC, measurement information associated with the channel quality estimation, the calculation of the at least one beamforming weight, and the port reduction.

40. The method of claim 39, wherein the REC comprises an O-RAN distributed unit, O-DU, and the RE comprises an O-RAN radio unit, O-RU.

41. The method of any claim 39, further comprising:
performing at least one measurement during the performance of the channel quality estimation, the calculation of at least one beamforming weight, and the port reduction, and
wherein the measurement information is based on performing the at least one measurement.

42. The method of claim 41, wherein the at least one measurement comprises at least one Signal-to-Noise/Interference-Ratio, SNIR, measurement, and wherein the measurement information comprises at least one value associated with the at least one SNIR measurement.

43. The method of claim 42, wherein the at least one measurement comprises a plurality of SNIR measurements, and wherein each SNIR measurement is associated with at least one of a frequency resolution and a time resolution.

44. The method of claim 41, wherein the at least one measurement comprises at least one Timing Advance, TA, measurement, and wherein the measurement information comprises at least one value associated with the at least one TA measurement.

45. The method of claim 41, wherein the at least one measurement comprises at least one Frequency Offset measurement, and wherein the measurement information comprises at least one value associated with the at least one Frequency Offset measurement.

46. A method by at least one radio equipment controller, REC, of a network node comprising:
receiving, from at least one radio equipment, RE, measurement information, the measurement information associated with:
a channel quality estimation performed by the RE,
a calculation of at least one beamforming weight by the RE, and
a port reduction by the RE.

47. The method of claim 46, comprising using the measurement information to perform demodulation and/or decoding.

48. The method of claim 46, comprising using the measurement information to generate information and/or messages to be sent to the UE via the RE.

49. The method of claim 46, wherein the RE comprises an O-RAN radio unit, O-RU, and the REC comprises an O-RAN distributed unit, O-DU.

50. The method of claim 46, wherein the measurement information is based on at least one measurement performed by the RE.

51. The method of claim 50, wherein the measurement information comprises at least one value associated with at least one Signal-to-Noise/Interference-Ratio, SNIR, measurement performed by the RE.

52. The method of claim 51, wherein the at least one value comprises a plurality of SNIR values associated with a plurality of SNIR measurements performed by the RE, and wherein each SNIR value and/or each SNIR measurement is associated with a at least one of a frequency resolution and a time resolution.

53. The method of claim 46, wherein the measurement information comprises at least one value associated with at least one Timing Advance, TA, measurement performed by the RE.

54. The method of claim 46, wherein the measurement information comprises at least one value associated with at least one Frequency Offset measurement performed by the RE.

55. A radio equipment, RE, of a network node is adapted to:
with respect to input data and/or an input signal, perform:
a channel quality estimation,
a calculation of at least one beamforming weight, and
a beamforming; and
transmit, to a radio equipment controller, REC, measurement information associated with:
the channel quality estimation,
the calculation of the at least one beamforming weight, and the port reduction.

56. A radio equipment controller, REC, of a network node is adapted to:
receive, from at least one radio equipment, RE, measurement information, the measurement information associated with:
a channel quality estimation performed by the RE,
a calculation of at least one beamforming weight by the RE, and
a port reduction by the RE.
